(19) United States
(12) Patent Application Publication
(10) Pub. No.: US 2024/0175343 A1
(43) Pub. Date: May 30, 2024

(54) SUITABILITY EVALUATION METHOD FOR DEVELOPING UNDERGROUND COAL GASIFICATION ENGINEERING BY UTILIZING DEEP COAL SEAM

(71) Applicant: Anhui university of science and technology, Huainan (CN)

(72) Inventors: Qinghe Zhang, Huainan (CN); Zhiwei Liang, Huainan (CN); Liang Yuan, Huainan (CN); Pingsong Zhang, Huainan (CN); Fawang Yang, Huainan (CN); Tong Zhang, Huainan (CN)

(21) Appl. No.: 18/543,116

(22) Filed: Dec. 18, 2023

Related U.S. Application Data
(63) Continuation of application No. PCT/CN2023/089648, filed on Apr. 21, 2023.

(30) Foreign Application Priority Data
Oct. 27, 2022 (CN) 202211323999.4

(51) Int. Cl. E21B 43/295

(52) U.S. Cl. CPC E21B 43/295

(57) ABSTRACT

Disclosed is a suitability evaluation method for developing underground coal gasification (UCG) engineering by utilizing a deep coal seam, including: acquiring basic geological conditions, engineering geological problems, hydrogeological conditions, contained coal quality, deep coal seam conditions, and heat and syngas components of unit coal gasification in a deep coal seam region to obtain scores of corresponding influencing factors; determining impact indexes of the geological condition and influencing factors; and determining the suitability of developing UCG engineering by utilizing the deep coal seam according to a comprehensive impact index. The suitability of developing UCG engineering by utilizing the deep coal seam is evaluated by a comprehensive analysis method.

### CROSS-REFERENCE TO RELATED APPLICATIONS

This application is a continuation of PCT/CN2023/089648, filed Apr. 21, 2023 and claims priority of Chinese Patent Application No. 202211323999.4, filed on Oct. 27, 2022, the entire contents of which are incorporated herein by reference.

### TECHNICAL FIELD

The present disclosure belongs to the technical field of underground coal gasification (UCG) engineering, and particularly relates to a suitability evaluation method for developing UCG engineering by utilizing a deep coal seam.

### BACKGROUND

The statements in this section merely provide background information related to the present disclosure and do not necessarily constitute prior art.

As society and the economy are developing, the demand for coal energy and the depth of coal mining are increasing, and the mining of deep coal resources is inevitable. However, the deep mining of coal mine has more risk factors, for example, with deeper mining, the ground stress significantly increases to cause intenser stress around a roadway, the roadway deformation rate is fast, the deformation is large and the roadway support becomes extremely complex, which is not conducive to the operation; and at the same time, the high temperature in the deep mine is prone to cause the high temperature and heat damages in the mine, which affects the production efficiency of workers, and the safety production cannot be ensured due to the high accident rate. In addition, the deep mining of coal mines also has the dangers of coal seam gas outburst and rock burst, and higher mine flood probability and coal seam spontaneous combustion probability due to the obvious increase of seepage pressure caused by high stress and high temperature.

UCG is a potential new method for exploiting energy from coal, which can be used in deep coal seams. UCG is also referred to as in-situ coal gasification. The method is to establish a gasification reaction furnace at a position where coal and carbon are located and perform controllable combustion of coal under in-situ conditions, so that the coal is directly converted into combustible gas in-situ to generate a mixed gas, and then converted into various fuels or raw materials after classification on the ground. The technology has the high coal recovery rate, lower economic cost, less environmental impact and higher safety performance compared with ground gasification. In addition, the UCG also avoids environmental problems such as ground dust and gangue stacking, and effectively reduces the pollution and economic loss caused by coal during transportation. At the same time, the technology avoids the geological problems of high ground stress and high ground temperature in the deep coal seams, and can promote the development and utilization of the deep coal.

In summary, UCG, as a new generation of in-situ coal mining technology, integrates coal mining and coal conversion, which has the advantages of safety, environmental protection, high efficiency and good economic benefits, and can realize underground unmanned production, fundamentally avoiding the casualties caused by various mine accidents. The research on UCG in the past century shows that UCG can make coal a clean, effective and cheap energy source. However, at present, there is no the suitability evaluation method for developing UCG engineering by utilizing the deep coal seam.

### SUMMARY

In order to solve the above problems, the present disclosure provides a suitability evaluation method for developing UCG engineering by utilizing a deep coal seam. The present disclosure considers the suitability of developing UCG in the deep coal seam from the aspects of safety, economy, technology and environmental protection, and divides a geological condition and engineering geological influencing factor, a hydrogeological condition influencing factor, a coal quality influencing factor, a coal seam condition influencing factor and an influencing factor of heat and syngas components of unit coal gasification in detail. Through these five specific influencing factors, the suitability of developing UCG engineering in the deep coal seam is evaluated by a comprehensive analysis method.

According to some examples, the present disclosure provides a suitability evaluation method for developing UCG engineering by utilizing a deep coal seam, adopting the following technical solutions.

A suitability evaluation method for developing UCG engineering by utilizing a deep coal seam includes:
acquiring basic geological conditions, engineering geological problems, hydrogeological conditions, contained coal quality, deep coal seam conditions, and heat and syngas components of unit coal gasification in a deep coal seam region, and comparing with evaluation criteria of influencing factors of the basic geological conditions, engineering geological problems, hydrogeological conditions, contained coal quality, deep coal seam conditions, and heat and syngas components of unit coal gasification in the deep coal seam region to obtain scores of corresponding influencing factors;
determining impact indexes of a geological condition and engineering geological influencing factor, a hydrogeological condition influencing factor, a coal quality influencing factor, a coal seam condition influencing factor and an influencing factor of heat and syngas components of unit coal gasification according to scores of various influencing factors of the deep coal seam; and
calculating a comprehensive impact index based on the impact indexes of the various influencing factors of the deep coal seam, and determining the suitability of developing UCG engineering by utilizing the deep coal seam according to the comprehensive impact index.

Further, the impact index is specifically as follows:

$$\\ Q = {\sum }_{i = 1}^{n} {M}_{i} / {\sum }_{i = 1}^{n} {M}_{imax}$$

where n is the number of impact factors corresponding to the influencing factors, Mᵢ is a score value of an i^{th} impact factor of the influencing factor, and Mᵢₘₐₓ is a maximum score value of the i^{th} impact factor of the influencing factor.

Further, the determining an impact index of a geological condition and engineering geological influencing factor according to scores of various influencing factors of the deep coal seam is specifically as follows:

$$\\ {Q}_{1} = {\sum }_{i = 1}^{n} {U}_{i} / {\sum }_{i = 1}^{n} {U}_{imax}$$

where Q₁ is a result of the geological condition and engineering geological influencing factor, n is the number of impact factors corresponding to the influencing factors, Uᵢ is a score value of an i^{th} impact factor of the geological condition and engineering geological influencing factor, and Uᵢₘₐₓ is a maximum score value of the i^{th} impact factor of the geological condition and engineering geological influencing factor.

Further, the determining an impact index of a hydrogeological condition influencing factor according to scores of various influencing factors of the deep coal seam is specifically as follows:

$$\\ {Q}_{2} = {\sum }_{i = 1}^{n} {V}_{i} / {\sum }_{i = 1}^{n} {V}_{imax}$$

where Q₂ is a result of the hydrogeological condition influencing factor, n is the number of impact factors corresponding to the influencing factors, Vᵢ is a score value of an i^{th} impact factor of the hydrogeological condition influencing factor, and Vᵢₘₐₓ is a maximum score value of the i^{th} impact factor of the hydrogeological condition influencing factor.

Further, the determining an impact index of a coal quality influencing factor according to scores of various influencing factors of the deep coal seam is specifically as follows:

$$\\ {Q}_{3} = {\sum }_{i = 1}^{n} {W}_{i} / {\sum }_{i = 1}^{n} {W}_{imax}$$

where Q₃ is a result of the coal quality influencing factor, n is the number of impact factors corresponding to the influencing factors, Wᵢ is a score value of an i^{th} impact factor of the coal quality influencing factor, and Wᵢₘₐₓ is a maximum score value of the i^{th} impact factor of the coal quality influencing factor.

Further, the determining an impact index of a coal seam condition influencing factor according to scores of various influencing factors of the deep coal seam is specifically as follows:

$$\\ {Q}_{4} = {\sum }_{i = 1}^{n} {X}_{i} / {\sum }_{i = 1}^{n} {X}_{imax}$$

where Q₄ is a result of the coal seam condition influencing factor, n is the number of impact factors corresponding to the influencing factor, Xᵢ is a score value of an i^{th} impact factor of the coal seam condition influencing factor, and Xᵢₘₐₓ is a maximum score value of the i^{th} impact factor of the coal seam condition influencing factor.

Further, the determining an impact index of an influencing factor of heat and syngas components of unit coal gasification according to scores of various influencing factors of the deep coal seam is specifically as follows:

$$\\ {Q}_{5} = {\sum }_{i = 1}^{n} {Z}_{i} / {\sum }_{i = 1}^{n} {Z}_{imax}$$

where Q₅ is a result of the influencing factor of heat and syngas components of unit coal gasification, n is the number of impact factors corresponding to the influencing factor, Zᵢ is a score value of an i^{th} impact factor of the influencing factor of heat and syngas components of unit coal gasification, and Zᵢₘₐₓ is a maximum score value of the i^{th} impact factor of the influencing factor of heat and syngas components of unit coal gasification.

Further, the calculating a comprehensive impact index based on the impact indexes of the various influencing factors of the deep coal seam specifically includes:
acquiring the impact indexes of the various influencing factors of the deep coal seam, and recording the calculated results as Q₁, Q₂, Q₃, Q₄ and Q₅ according to the sequence of the geological condition and engineering geological influencing factor, the hydrogeological condition influencing factor, the coal quality influencing factor, the coal seam condition influencing factor and the influencing factor of heat and syngas components of unit coal gasification; and
determining the calculated comprehensive impact index Q=Min {Q₁, Q₂, Q₃, Q₄, Q₅}.

Further, the determining the suitability of developing UCG engineering by utilizing the deep coal seam according to the comprehensive impact index specifically includes:
comparing the comprehensive impact index with a comprehensive impact index corresponding to a preset suitability grade; and
determining the suitability of developing UCG engineering by utilizing the deep coal seam according to comparison results.

Further, the suitability of developing UCG engineering by utilizing the deep coal seam is determined by comparing a numerical minimum comprehensive impact index with the comprehensive impact index corresponding to the preset suitability grade.

Compared with the related art, the present disclosure has the following beneficial effects.

The present disclosure considers the suitability of developing UCG in the deep coal seam from the aspects of safety, economy, technology and environmental protection, and divides the geological condition and engineering geological influencing factor, the hydrogeological condition influencing factor, the coal quality influencing factor, the coal seam condition influencing factor and the influencing factor of heat and syngas components of unit coal gasification in detail. Through these five specific influencing factors, the suitability of developing UCG engineering in the deep coal seam is evaluated by a comprehensive analysis method.

According to the present disclosure, by scientifically and comprehensively evaluating the suitability of developing UCG engineering in coal mines, the suitability of developing UCG engineering in the coal mines can be comprehensively, accurately and efficiently obtained to provide scientific bases for evaluating the development of UCG engineering in the coal mines.

### BRIEF DESCRIPTION OF THE DRAWINGS

The attached drawings, which constitute a part of the present disclosure, are used to provide a further understanding of the present disclosure, and the illustrative examples of the present disclosure and descriptions are used to explain the present disclosure, and do not constitute undue limitations on the present disclosure.

FIG. 1 is a suitability evaluation method for developing UCG engineering by utilizing a deep coal seam according to an example of the present disclosure.

### DETAILED DESCRIPTION

The present disclosure will be further described with reference to the attached drawings and examples.

It is to be pointed out that the following detailed description is exemplary and is intended to provide further explanation of the present disclosure. Unless otherwise specified, all technical and scientific terms used herein have the same meaning as commonly understood by ordinary technical personnel in the technical field to which the present disclosure belongs.

It is to be noted that the terms used here are only for describing the detailed implementations, and are not intended to limit exemplary implementations according to the present disclosure. As used herein, the singular form is also intended to include the plural form unless the context clearly indicates otherwise. Furthermore, it is also to be understood that when the terms “comprising” and/or “including” are used in this specification, the presence of features, steps, operations, devices, components and/or combinations thereof is indicated.

In the case of no conflict, the examples in the present disclosure and the features in the examples can be combined with each other.

### Example One

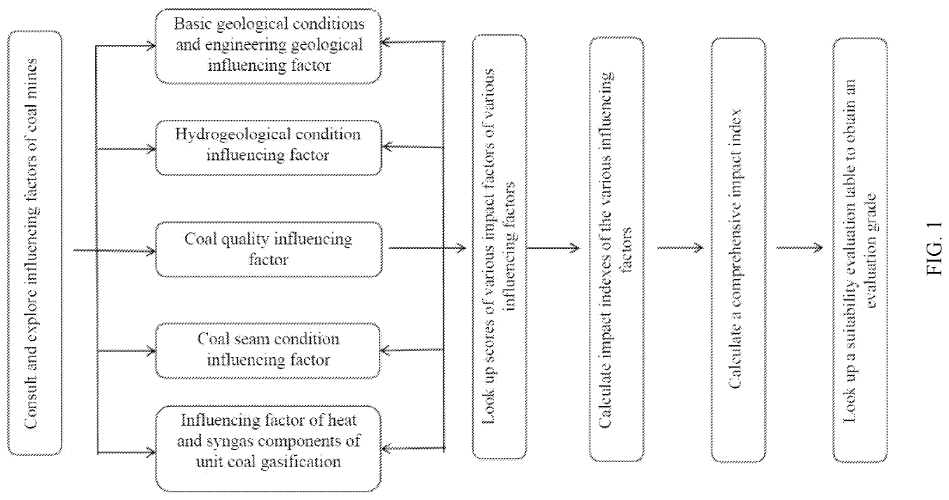

As shown in FIG. 1, the present example provides a suitability evaluation method for developing UCG engineering by utilizing a deep coal seam. In the example, the method includes the following steps.

At step 1: data of basic geological conditions and engineering geological problems in a deep coal seam region were acquired and compared with a pre-established evaluation criterion for a geological condition and engineering geological influencing factor to determine a score of the geological condition and engineering geological influencing factor for developing UCG engineering in the deep coal seam.

At step 2: data of hydrogeological conditions in the deep coal seam region were acquired and compared with a pre-established evaluation criterion for a hydrogeological condition influencing factor to determine scores of various impact factors of the hydrogeological conditions for developing UCG engineering in the deep coal seams.

At step 3: the quality data of the coal contained in the deep coal seam region were acquired and compared with a pre-established evaluation criterion for a coal quality influencing factor in the deep coal seam region to determine scores of various influencing factors of the coal quality for developing UCG engineering in the deep coal seam.

At step 4: data of deep coal seam conditions were acquired and compared with a pre-established evaluation criterion for a coal seam condition influencing factor to obtain scores of influencing factors of the coal seam conditions for developing UCG engineering in the deep coal seam.

At step 5: the heat and syngas components in the process of indoor test measurement of UCG of the coal carbon in the unit deep coal seam were acquired and compared with a pre-established evaluation criterion for an influencing factor of heat and syngas components of unit coal gasification to obtain scores of various influencing factors of the heat and syngas components for developing UCG engineering in the deep coal seam.

At step 6: impact indexes of the geological condition and engineering geological influencing factor, the hydrogeological condition influencing factor, the coal quality influencing factor, the coal seam condition influencing factor and the influencing factor of heat and syngas components of unit coal gasification in steps 1 to 5 were calculated.

At step 7: a comprehensive impact index was calculated, and the suitability of developing UCG engineering by utilizing the deep coal seam was determined according to the comprehensive impact index.

At step 1: the consulting and on-site exploration were performed on the basic geological conditions and engineering geological problems in the deep coal seam region. According to an evaluation table of the geological condition and engineering geological influencing factor, as shown in Table 1, the score of the geological condition and engineering geological influencing factor for developing UCG engineering in the deep coal seam was obtained. In this implementation case, the coal mine region has a rock grade of II, an earthquake magnitude of 3, a rock weathering degree of weak weathering, a surface slope of 4°, a coal seam buried depth of 150 m, a distance of 9 km from a residential area, a distance of 6 km from a production mine, and a distance of 5 km from an abandoned mine. The scores are shown in Table 1 below.

TABLE 1
Evaluation table of geological conditions and
engineering geological influencing factors

| | | Impact factor | |
|---|---|---|---|
| No. | Impact factor | grading criteria | Score |
| U₁ | Rock grade of coal | I-II | 5 |
| | seam | III-IV | 3 |
| | | V | 1 |
| | | VI | −3 |
| | | VII-X | −5 |
| U₂ | Earthquake magnitude | <2 | 4 |
| | | 2-3 | 3 |
| | | 3-4 | 2 |
| | | 4-5 | 1 |
| | | >5 | −1 |
| U₃ | Rock weathering | Unweathered | 4 |
| | degree | Weak weathering | 3 |
| | | Moderate | 2 |
| | | weathering | |
| | | Strong weathering | 1 |
| | | Completely | −1 |
| | | weathered | |
| U₄ | Surface slope/° | <3 | 3 |
| | | 3-5 | 2 |
| | | 5-7 | 1 |
| | | 7-10 | −1 |
| | | >10 | −2 |
| U₅ | Coal seam buried | >300 | 5 |
| | depth/m | 200-300 | 3 |
| | | 150-200 | 1 |
| | | 50-150 | −3 |
| | | <50 | −5 |
| U₆ | Distance from | 3-5 | 3 |
| | residential area/km | 5-7 | 2 |
| | | 7-9 | 1 |
| | | 9-11 | −1 |
| | | >11or <3 | −2 |
| U₇ | Distance from | 5-6 | 3 |
| | production mine/km | 6-7 | 2 |
| | | 7-8 | 1 |
| | | 8-9 | −1 |
| | | >9 or <5 | −2 |
| U₈ | Distance from | >10 | 3 |
| | abandoned mine/km | 8-10 | 2 |
| | | 6-8 | 1 |
| | | 4-6 | −1 |
| | | <4 | −2 |

At step 2: the consulting and on-site exploration were performed on the hydrogeological conditions in the deep coal seam region. According to an evaluation table of the hydrogeological condition influencing factor, as shown in Table 2, scores of various impact factors of the hydrogeological conditions for developing UCG engineering in the deep coal seam were obtained. In this implementation case, the coal mine has a distance of 8 km from a lake, a coal seam permeability of 130/10⁻¹⁵ m², a direct roof permeability of 6/10⁻¹⁵ m², a groundwater level of 170 m, a position of a coal seam 23 m from still water aquifer, a distance of 30 m from the aquifer with flowing water, a water inflow into the coal seam of 2.1 m³·t⁻¹, and a water inflow of a gasification working face of 0.6 m³·t⁻¹. The scores are shown in Table 2 below.

TABLE 2
Evaluation table of hydrogeological condition influencing factors

| | | Impact factor | |
|---|---|---|---|
| No. | Impact factor | grading criteria | Score |
| V₁ | Distance from | >10 | 3 |
| | lake/km | 8-10 | 2 |
| | | 6-8 | 1 |
| | | 4-6 | 0 |
| | | <4 | −1 |
| V₂ | Coal seam | 50-100 | 4 |
| | permeability/10⁻¹⁵m² | 100-150 | 3 |
| | | 150-200 | 2 |
| | | 200-250 | 1 |
| | | >250 or <50 | −1 |
| V₃ | Direct roof | <5 | 4 |
| | permeability/10⁻¹⁵m² | 5-10 | 3 |
| | | 10-15 | 2 |
| | | 15-20 | 1 |
| | | <20 | −1 |
| V₄ | Groundwater | <50 | 3 |
| | level/m | 50-150 | 2 |
| | | 150-200 | 1 |
| | | 200-300 | −1 |
| | | >300 | −2 |
| V₅ | Position of coal | >30 | 4 |
| | seam from still | 25-30 | 3 |
| | water aquifer/m | 20-25 | 2 |
| | | 15-20 | 1 |
| | | <15 | −1 |
| V₆ | Distance from | >100 | 3 |
| | aquifer with | 80-100 | 2 |
| | flowing water/m | 60-80 | 1 |
| | | 40-60 | −1 |
| | | <40 | −2 |
| V₇ | Water inflow into | <2 | 3 |
| | coal seam/m³ · t⁻¹ | 2-3 | 2 |
| | | 3-4 | 1 |
| | | 4-5 | −1 |
| | | >5 | −2 |
| V₈ | Water inflow of | <0.4 | 3 |
| | gasification | 0.4-0.6 | 2 |
| | working face/m³ · t⁻¹ | 0.6-0.8 | 1 |
| | | 0.8-1 | −1 |
| | | >1 | −2 |

At step 3: the quality of the coal contained in the deep coal seam region was understood and investigated. According to an evaluation table of the coal quality influencing factor in the deep coal seam region, as shown in Table 3, scores of various influencing factors of the coal quality for developing UCG engineering in the deep coal seam were obtained. In this implementation case, the coal mine has a moisture content of 10%, a total sulfur content of 0.1%, an ash yield of 30%, a volatile content of 45%, a fixed carbon of 37%, a bond index of 18, a gangue content of 3%, and a Roga index of 23. The scores are shown in Table 3 below.

TABLE 3
Evaluation table of coal quality influencing
factors in deep coal seam region

| | | Impact factor | |
|---|---|---|---|
| No. | Impact factor | grading criteria | Score |
| W₁ | Moisture | <10 | 5 |
| | content/% | 10-15 | 3 |
| | | 15-18 | 1 |
| | | 18-20 | −3 |
| | | >20 | −5 |
| W₂ | Total sulfur | <0.05 | 5 |
| | content/% | 0.05-0.1 | 3 |
| | | 0.1-0.15 | 1 |
| | | 0.15-0.2 | −3 |
| | | >0.2 | −5 |
| W₃ | Ash yield/% | <30 | 4 |
| | | 30-40 | 3 |
| | | 40-50 | 1 |
| | | 50-60 | −1 |
| | | >60 | −3 |
| W₄ | Volatile | >50 | 3 |
| | content/% | 40-50 | 2 |
| | | 30-40 | 0 |
| | | 20-30 | −1 |
| | | <20 | −2 |
| W₅ | Fixed carbon/% | >50 | 4 |
| | | 40-50 | 3 |
| | | 30-40 | 1 |
| | | 20-30 | −1 |
| | | <20 | −3 |
| W₆ | Bond index | <5 | 4 |
| | | 5-10 | 3 |
| | | 10-15 | 1 |
| | | 15-20 | −1 |
| | | <20 | −3 |
| W₇ | Gangue content/% | <2 | 3 |
| | | 2-3 | 2 |
| | | 3-4 | 1 |
| | | 4-5 | −1 |
| | | >5 | −2 |
| W₈ | Coal grade/Roga | <20 | 4 |
| | index | 20-25 | 3 |
| | | 25-30 | 2 |
| | | 30-35 | −1 |
| | | >35 | −2 |

At step 4: the deep coal seam situations were understood and investigated. According to an evaluation table of the coal seam situation influencing factor, as shown in Table 4, a score of the coal seam situation influencing factor for developing UCG engineering in the deep coal seam was obtained. In this implementation case, the coal seam of the coal mine has a coal seam thickness of 6 m, an overlying impermeable rock thickness of 13 m, an interbedded gangue thickness of 1.3 m, a distance of 175 m from a fault, a coal resource content of 4.2 Mt, a coal seam porosity of 20%, a methane content of 3.5 m³·t⁻¹ and a coal seam inclination angle of 7° The scores are shown in Table 4 below.

TABLE 4
Evaluation table of coal seam condition influencing factors

| | Impact | Impact factor | |
|---|---|---|---|
| No. | factor | grading criteria | Score |
| X₁ | Coal seam | 7-10 | 5 |
| | thickness/m | 5-7 | 3 |
| | | 3-5 | 1 |
| | | 1-3 | −3 |
| | | <1 | −5 |
| X₂ | Overlying | >20 | 4 |
| | impermeable rock | 15-20 | 3 |
| | thickness/m | 10-15 | 2 |
| | | 5-10 | −1 |
| | | <5 | −2 |
| X₃ | Interbedded gangue | <0.5 | 4 |
| | thickness/m | 0.5-1 | 3 |
| | | 1-1.5 | 2 |
| | | 1.5-2 | −1 |
| | | >2 | −3 |
| X₄ | Distance from | >300 | 3 |
| | fault/m | 200-300 | 2 |
| | | 150-200 | 1 |
| | | 50-150 | −1 |
| | | <50 | −2 |
| X₅ | Coal resource | >4 | 5 |
| | content/Mt | 3.5-4 | 3 |
| | | 3-3.5 | 1 |
| | | 2.5-3 | −3 |
| | | <2.5 | −5 |
| X₆ | Coal seam | <20 | 3 |
| | porosity/% | 20-15 | 2 |
| | | 25-30 | 1 |
| | | 30-35 | −1 |
| | | >35 | −2 |
| X₇ | Methane | <1 | 3 |
| | content/m³ · t⁻¹ | 1-2 | 2 |
| | | 2-3 | 1 |
| | | 3-4 | −1 |
| | | >4 | −2 |
| X₈ | Coal seam | <10 | 3 |
| | inclination | 10-15 | 2 |
| | angle/° | 15-20 | 1 |
| | | 20-25 | −1 |
| | | <25 | −2 |

At step 5: the heat and syngas components in the process of indoor test measurement of UCG of the coal carbon in the unit deep coal seam were acquired. According to an evaluation table of the influencing factor of the heat and syngas components of the unit coal gasification, as shown in Table 5, scores of various influencing factors of the heat and syngas components of the UCG engineering in the deep coal seam were obtained. In this implementation case, the coal mine has a unit coal gas production of 3 m³·kg⁻¹, a coal consumption rate of 1.4 kg·h⁻¹, a hydrogen content of 7%, a sulfur dioxide content of 0.6%, a methane content of 17%, a gas calorific value of 14 MJ·m⁻³, a unit coal calorific value of 26 MJ·m⁻³ and an energy recovery rate of 72%. The scores are shown in Table 5 below.

TABLE 5
Evaluation table of influencing factors of heat
and syngas components of unit coal gasification

| | | Impact factor grading | |
|---|---|---|---|
| No. | Impact factor | criteria | Score |
| Z₁ | Unit coal gas | >2 | 5 |
| | production/m³ · kg⁻¹ | 1.5-2 | 3 |
| | | 1-1.5 | 1 |
| | | 0.5-1 | −3 |
| | | <0.5 | −5 |
| Z₂ | Coal consumption | >2 | 4 |
| | rate/kg · h⁻¹ | 1.5-2 | 3 |
| | | 1-1.5 | 2 |
| | | 0.5-1 | 1 |
| | | <0.5 | −1 |
| Z₃ | Hydrogen content/% | >10 | 4 |
| | | 8-10 | 3 |
| | | 6-8 | 2 |
| | | 4-6 | 1 |
| | | <4 | −1 |
| Z₄ | Sulfur dioxide content/% | <0.5 | 1 |
| | | 0.5-1 | −1 |
| | | 1-1.5 | −2 |
| | | 1.5-2 | −3 |
| | | >2 | −4 |
| Z₅ | Methane content/% | >15 | 4 |
| | | 12-15 | 3 |
| | | 9-12 | 2 |
| | | 6-9 | 1 |
| | | <6 | −1 |
| Z₆ | Gas calorific | >15 | 4 |
| | value/MJ · m⁻³ | 13-15 | 3 |
| | | 10-13 | 2 |
| | | 7-10 | −1 |
| | | <7 | −2 |
| Z₇ | Unit coal calorific | >30 | 3 |
| | value/MJ · m⁻³ | 25-30 | 2 |
| | | 20-25 | 1 |
| | | 15-20 | −1 |
| | | <15 | −2 |
| Z₈ | Energy recovery rate/% | >70 | 3 |
| | | 60-70 | 2 |
| | | 50-60 | 1 |
| | | 40-50 | −1 |
| | | <40 | −2 |

At step 6: impact indexes of the geological condition and engineering geological influencing factor, the hydrogeological condition influencing factor, the coal quality influencing factor, the coal seam condition influencing factor and the influencing factor of heat and syngas components of unit coal gasification in steps 1 to 5 were calculated, and the formula is as follows:

$$\\ Q = {\sum }_{i = 1}^{n} {M}_{i} / {\sum }_{i = 1}^{n} {M}_{imax}$$

where n is the number of impact factors corresponding to the influencing factors, Mᵢ is a score value of an i^{th} impact factor of the influencing factor, and Mᵢₘₐₓ is a maximum score value of the i^{th} impact factor of the influencing factor. The calculated results in step 6 were recorded as Q₁, Q₂, Q₃, Q₄ and Q₅ according to the sequence of the geological condition and engineering geological influencing factor, the hydrogeological condition influencing factor, the coal quality influencing factor, the coal seam condition influencing factor and the influencing factor of heat and syngas components of unit coal gasification:

$$\\ {Q}_{1} = {\sum }_{i = 1}^{n} {U}_{i} / {\sum }_{i = 1}^{n} {U}_{imax} = 16 / 30 = 0.533$$

$$\\ {Q}_{2} = {\sum }_{i = 1}^{n} {V}_{i} / {\sum }_{i = 1}^{n} {V}_{imax} = 13 / 23 = 0.565$$

$$\\ {Q}_{3} = {\sum }_{i = 1}^{n} {W}_{i} / {\sum }_{i = 1}^{n} {W}_{imax} = 16 / 28 = 0.571$$

$$\\ {Q}_{4} = {\sum }_{i = 1}^{n} {X}_{i} / {\sum }_{i = 1}^{n} {X}_{imax} = 17 / 30 = 0.567$$

$$\\ {Q}_{5} = {\sum }_{i = 1}^{n} {Z}_{i} / {\sum }_{i = 1}^{n} {Z}_{imax} = 20 / 28 = 0.741$$

At step 7: the comprehensive impact index Q=Min {Q₁, Q₂, Q₃, Q₄, Q₅} was calculated, and the suitability of developing UCG engineering by utilizing the deep coal seam was determined according to the following suitability evaluation table, as shown in Table 6:

Q=Min {Q₁, Q₂, Q₃, Q₄, Q₅}=Min {0.533, 0.565, 0.571, 0.567, 0.714}=0.533, by looking up the suitability evaluation table, it can be concluded that the suitability of developing coal gasification in the deep coal seam is more suitable.

TABLE 6
Suitability evaluation table

| Grade | Q value |
|---|---|
| Very suitable | >0.8 |
| Suitable | 0.6-0.8 |
| More suitable | 0.4-0.6 |
| Slightly poor suitability | 0.2-0.4 |
| Poor suitability | <0.2 |

The suitability evaluation method described in the example is mainly applied to gasification engineering design, decision-making or site selection, specifically including: before the deep coal seam is utilized to develop UCG engineering, it is necessary to make exploration on the geological conditions, surrounding environment and coal quality of the deep coal seam to determine whether the underground coal engineering can be developed in the deep coal seam, otherwise many hazards may occur, for example: rock around the coal seam is unstable, resulting in rock collapse during gasification.

In the example, the suitability of developing UCG in the deep coal seam is evaluated by comprehensively considering five factors, i. e. the geological condition and engineering geological influencing factor, the hydrogeological condition influencing factor, the coal quality influencing factor, the coal seam condition influencing factor, and the influencing factor of heat and syngas components of unit coal gasification to provide a method for selecting a suitable deep coal seam for developing UCG engineering.

Although the detailed implementations of the present disclosure have been described above with reference to the attached drawings, it is not intended to limit the scope of protection of the present disclosure. It it to be understood by those skilled in the art that on the basis of the technical solutions of the present disclosure, various modifications or variations that can be made by those skilled in the art without creative effort are still within the scope of protection of the present disclosure.

1. A suitability evaluation method for developing underground coal gasification (UCG) engineering by utilizing a deep coal seam, comprising:
acquiring basic geological conditions, engineering geological problems, hydrogeological conditions, contained coal quality, deep coal seam conditions, and heat and syngas components of unit coal gasification in a deep coal seam region, and comparing with evaluation criteria of influencing factors of the basic geological conditions, engineering geological problems, hydrogeological conditions, contained coal quality, deep coal seam conditions, and heat and syngas components of unit coal gasification in the deep coal seam region to obtain scores of corresponding influencing factors;
determining impact indexes of a geological condition and engineering geological influencing factor, a hydrogeological condition influencing factor, a coal quality influencing factor, a coal seam condition influencing factor and an influencing factor of heat and syngas components of unit coal gasification according to scores of various influencing factors of the deep coal seam; and
calculating a comprehensive impact index based on the impact indexes of the various influencing factors of the deep coal seam, and determining the suitability of developing UCG engineering by utilizing a deep coal seam according to the comprehensive impact index.

2. The suitability evaluation method of developing UCG engineering by utilizing a deep coal seam according to claim 1, wherein the impact index is specifically as follows:
$$\\ Q = {\sum }_{i = 1}^{n} {M}_{i} / {\sum }_{i = 1}^{n} {M}_{imax}$$
wherein n is the number of impact factors corresponding to the influencing factors, Mᵢ is a score value of an i^{th} impact factor of the influencing factor, and Mᵢₘₐₓ is a maximum score value of the i^{th} impact factor of the influencing factor.

3. The suitability evaluation method of developing UCG engineering by utilizing a deep coal seam according to claim 1, wherein the determining an impact index of a geological condition and engineering geological influencing factor according to scores of various influencing factors of the deep coal seam is specifically as follows:
$$\\ {Q}_{1} = {\sum }_{i = 1}^{n} {U}_{i} / {\sum }_{i = 1}^{n} {U}_{imax}$$
wherein Q₁ is a result of the geological condition and engineering geological influencing factor, n is the number of impact factors corresponding to the influencing factors, Uᵢ is a score value of an i^{th} impact factor of the geological condition and engineering geological influencing factor, and Uᵢ, is a maximum score value of the i^{th} impact factor of the geological condition and engineering geological influencing factor.

4. The suitability evaluation method for developing UCG engineering by utilizing a deep coal seam according to claim 1, wherein the determining an impact index of a hydrogeological condition influencing factor according to scores of various influencing factors of the deep coal seam is specifically as follows:
$$\\ {Q}_{2} = {\sum }_{i = 1}^{n} {V}_{i} / {\sum }_{i = 1}^{n} {V}_{imax}$$
wherein Q₂ is a result of the hydrogeological condition influencing factor, n is the number of impact factors corresponding to the influencing factors, Vᵢ is a score value of an i^{th} impact factor of the hydrogeological condition influencing factor, and Vᵢₘₐₓ is a maximum score value of the i^{th} impact factor of the hydrogeological condition influencing factor.

5. The suitability evaluation method for developing UCG engineering by utilizing a deep coal seam according to claim 1, wherein the determining an impact index of a coal quality influencing factor according to scores of various influencing factors of the deep coal seam is specifically as follows:
$$\\ {Q}_{3} = {\sum }_{i = 1}^{n} {W}_{i} / {\sum }_{i = 1}^{n} {W}_{imax}$$
wherein Q₃ is a result of the coal quality influencing factor, n is the number of impact factors corresponding to the influencing factors, Wᵢ is a score value of an i^{th} impact factor of the coal quality influencing factor, and Wᵢₘₐₓ is a maximum score value of the i^{th} impact factor of the coal quality influencing factor.

6. The suitability evaluation method for developing UCG engineering by utilizing a deep coal seam according to claim 1, wherein the determining an impact index of a coal seam condition influencing factor according to scores of various influencing factors of the deep coal seam is specifically as follows:
$$\\ {Q}_{4} = {\sum }_{i = 1}^{n} {X}_{i} / {\sum }_{i = 1}^{n} {X}_{imax}$$
wherein Q₄ is a result of the coal seam condition influencing factor, n is the number of impact factors corresponding to the influencing factor, Xᵢ is a score value of an i^{th} impact factor of the coal seam condition influencing factor, and Xᵢₘₐₓ is a maximum score value of the i^{th} impact factor of the coal seam condition influencing factor.

7. The suitability evaluation method for developing UCG engineering by utilizing a deep coal seam according to claim 1, wherein the determining an impact index of an influencing factor of heat and syngas components of unit coal gasification according to scores of various influencing factors of the deep coal seam is specifically as follows:
$$\\ {Q}_{5} = {\sum }_{i = 1}^{n} {Z}_{i} / {\sum }_{i = 1}^{n} {Z}_{imax}$$
wherein Q₅ is a result of the influencing factor of heat and syngas components of unit coal gasification, n is the number of impact factors corresponding to the influencing factor, Zᵢ is a score value of an i^{th} impact factor of the influencing factor of heat and syngas components of unit coal gasification, and Zᵢₘₐₓ is a maximum score value of the i^{th} impact factor of the influencing factor of heat and syngas components of unit coal gasification.

8. The suitability evaluation method for developing UCG engineering by utilizing a deep coal seam according to claim 1, wherein the calculating a comprehensive impact index based on the impact indexes of the various influencing factors of the deep coal seam specifically comprises:
acquiring the impact indexes of the various influencing factors of the deep coal seam, and recording the calculated results as Q₁, Q₂, Q₃, Q₄ and Q₅ according to the sequence of the geological condition and engineering geological influencing factor, the hydrogeological condition influencing factor, the coal quality influencing factor, the coal seam condition influencing factor and the influencing factor of heat and syngas components of unit coal gasification; and
determining the calculated comprehensive impact index Q=Min {Q₁, Q₂, Q₃, Q₄, Q₅}.

9. The suitability evaluation method for developing UCG engineering by utilizing a deep coal seam according to claim 1, wherein the determining the suitability of developing UCG engineering by utilizing the deep coal seam according to the comprehensive impact index specifically comprises:
comparing the comprehensive impact index with a comprehensive impact index corresponding to a preset suitability grade; and
determining the suitability of developing UCG engineering by utilizing the deep coal seam according to comparison results.

10. The suitability evaluation method for developing UCG engineering by utilizing deep coal seams according to claim 9, wherein the suitability of developing UCG engineering by utilizing the deep coal seam is determined by comparing a numerical minimum comprehensive impact index with the comprehensive impact index corresponding to the preset suitability grade.
